(19) United States
(12) Patent Application Publication
(10) Pub. No.: US 2022/0407277 A1
(43) Pub. Date: Dec. 22, 2022

(54) ELECTRICAL CONNECTOR

(71) Applicant: HIROSE KOREA CO., LTD., Siheung-si (KR)

(72) Inventor: Chae Eun LIM, Siheung-si (KR)

(73) Assignee: HIROSE KOREA CO., LTD., Siheung-si (KR)

(21) Appl. No.: 17/842,404

(22) Filed: Jun. 16, 2022

(30) Foreign Application Priority Data
Jun. 18, 2021 (KR) 10-2021-0079101

(51) Int. Cl. H01R 43/24; H01R 13/405

(52) U.S. Cl. CPC H01R 43/24; H01R 13/405; H01R 12/716

(57) ABSTRACT

A method of manufacturing an electrical connector coupled to a counterpart connector is disclosed. The method includes: (a) disposing a plurality of signal terminals; (b) forming a first mold part to support the signal terminals through primary insert molding, the first mold part being formed to have a protrusion at one end thereof in a longitudinal direction of the electrical connector and a first groove at the other end thereof in the longitudinal direction of the electrical connector; (c) placing a fitting beside the first mold part; and (d) forming a second mold part to support the first mold part and the fitting through secondary insert molding, the second mold part being formed to surround the protrusion of the first mold part while filling the first groove.

### CROSS-REFERENCE(S) TO RELATED APPLICATION

This application claims the benefit of Korean Patent Application No. 10-2021-0079101, filed on Jun. 18, 2021, in the Korean Intellectual Property Office, the contents of which are incorporated herein by reference in its entirety.

### TECHNICAL FIELD

Embodiments of the present disclosure relate to an electrical connector, more particularly to an electrical connector in which a mold includes a first mold part having a protrusion and a groove and a second mold part surrounding, for example, four sides of the first mold part.

### BACKGROUND

In general, upon interconnection between boards, two connectors may be connected to each of the boards by soldering and the like and may be connected to each other. Here, one of the connectors is a plug connector and the other connector is a socket connector. The socket connector is also referred to as a receptacle connector. The plug connector and the socket connector may be formed by placing terminals on a mold. The plug connector and the socket connector may be fastened to each other to form an electrical connector assembly.

With a miniaturization trend of electric devices, miniaturization and low profile of connectors are also required in the art. However, there is a certain limit in miniaturization and low profile of the connectors through reduction in pitch or size of components.

On the other hand, as the connectors become smaller, it is also difficult to secure durability of the connectors. This is because a small connector can be easily broken even by small force.

In manufacturing molds of miniaturized connectors, it becomes more difficult to produce a desired shape at once. In addition, as the connectors are miniaturized, it becomes increasingly difficult to check whether terminals of the connectors are properly mounted on the board or in a state in which the terminals can be properly mounted thereon.

### SUMMARY

It is an object of the present disclosure to provide a mold having a desired complicated shape while securing sufficient strength and reliability through insert molding performed plural times.

It is another object of the present disclosure to provide a mold allowing easy monitoring as to whether terminals of a miniaturized connector are properly mounted on a board or in a state in which the terminals can be properly mounted thereon.

The present disclosure is not limited to the above objects and the above and other objects will become apparent by the detailed description of the present disclosure.

In accordance with one aspect of the present disclosure, a method of manufacturing an electrical connector coupled to a counterpart connector, including: (a) disposing a plurality of signal terminals; (b) forming a first mold part to support the signal terminals through primary insert molding, the first mold part being formed to have a protrusion at one end thereof in a longitudinal direction of the electrical connector and a first groove at the other end thereof in the longitudinal direction of the electrical connector, (c) placing a fitting beside the first mold part; and (d) forming a second mold part to support the first mold part and the fitting through secondary insert molding, the second mold part being formed to surround the protrusion of the first mold part while filling the first groove.

Preferably, in Step (b), a second groove is further formed on an inner wall of the first mold part to extend in the longitudinal direction of the electrical connector.

Preferably, the first mold part includes two first mold parts, and in Step (b), the second groove is formed on an outer wall of the first mold part and a third groove is further formed on an inner wall of the first mold part to extend in the longitudinal direction of the electrical connector.

Preferably, the second mold part is formed to surround four sides of the first mold part while surrounding the protrusion, the first groove, and the second groove.

In accordance with another aspect of the present disclosure, an electrical connector coupled to a counterpart connector includes: a plurality of signal terminals arranged in a longitudinal direction of the electrical connector; a first mold part supporting the plurality of signal terminals, the first mold part having a protrusion at one end thereof in the longitudinal direction of the electrical connector and a first groove at the other end thereof in the longitudinal direction of the electrical connector; a fitting disposed beside the first mold part; and a second mold part supporting the first mold part and the fitting, the second mold part surrounding the protrusion of the first mold part and filling the first groove.

Preferably, the first mold part is further formed with a second groove extending in the longitudinal direction of the electrical connector.

Preferably, the electrical connector includes two first mold parts; the second groove is formed on an outer wall of the first mold part; and a third groove is further formed on an inner wall of the first mold part to extend in the longitudinal direction of the electrical connector

Preferably, the second mold part is formed to surround four sides of the first mold part while surrounding the protrusion, the first groove, and the second groove.

According to the present disclosure, it is possible to form a mold having a desired complicated shape while securing sufficient strength and reliability through insert molding performed plural times.

Further, according to the present disclosure, a plurality of inspection windows 20-IW may be arranged in a zigzag shape. As a result, a wider space than an actual pitch between adjacent terminals can be used as a pitch of the terminals upon mounting. Further, due to the presence of the inspection windows 20-IW, which are vertical through-holes in the height direction (Z direction), mounted states of inner mounting portions 20-3IM can be easily checked through a camera or the like.

That is, the electrical connector according to the present disclosure allows an operator to easily check whether terminals of the miniaturized connector are properly mounted on a board (or can be properly mounted thereon).

It should be understood that the present disclosure is not limited to the above effects and other effects of the present disclosure will become apparent from the detailed description of the present disclosure.

### BRIEF DESCRIPTION OF THE DRAWINGS

The above and other aspects, features and advantages of the present disclosure will become apparent from the following description of embodiments given in conjunction with the accompanying drawings, in which:

FIG. 1 is a perspective view of one embodiment of a plug connector in an electrical connector according to the present disclosure.

FIG. 2 is a front view of the plug connector 10 of FIG. 1.

FIG. 3 is a bottom view of the plug connector 10 of FIG. 1.

FIG. 4 is a side view of the plug connector 10 of FIG. 1.

FIG. 5 is a perspective view of one embodiment of a socket connector of the electrical connector according to the present disclosure.

FIG. 6 is a front view of the socket connector 20 of FIG. 5.

FIG. 7 is a bottom view of the socket connector 20 of FIG. 5.

FIG. 8 is a side view of the socket connector 20 of FIG. 5.

FIG. 9 is a perspective view of another embodiment of the plug connector in the electrical connector according to the present disclosure.

FIG. 10 is a front view of the plug connector 10 of FIG. 9.

FIG. 11 is another perspective view of the plug connector 10 of FIG. 9 shown at a different angle.

FIG. 12 is a bottom view of the plug connector 10 of FIG. 9.

FIG. 13 is a perspective view of another embodiment of the socket connector in the electrical connector according to the present disclosure.

FIG. 14 is a front view of the socket connector 20 of FIG. 13.

FIG. 15 is another perspective view of the socket connector 20 of FIG. 13 shown at a different angle.

FIG. 16 is a bottom view of the socket connector 20 of FIG. 13.

FIG. 17 shows the steps of preparing a signal terminal 20-3 and a fitting 20-1 in formation of the socket connector 20 shown in FIGS. 13 to 16.

FIG. 18 shows the step of preparing a first mold part 20-5-1 in formation of the socket connector 20 shown in FIGS. 13 to 16.

FIG. 19 shows the step of removing a carrier after preparation of the first mold part 20-5-1 in formation of the socket connector 20 shown in FIGS. 13 to 16.

FIG. 20 shows the step of placing two first mold parts 20-5-1 in formation of the socket connector 20 shown in FIGS. 13 to 16.

FIG. 21 shows the step of placing the fitting 20-1 after placement of two first mold parts 20-5-1 in formation of the socket connector 20 shown in FIGS. 13 to 16.

FIG. 22 shows the step of insert molding a second mold part 20-5-2, with the first mold part 20-5-1 and the fitting 20-1 disposed in place, in formation of the socket connector 20 shown in FIGS. 13 to 16.

FIG. 23 is a top view of one embodiment of the first mold part 20-5-1 shown in FIG. 20.

FIG. 24 is a perspective view of the first mold part 20-5-1 shown in FIG. 23.

FIG. 25 shows another embodiment of the plug connector 10 according to the present disclosure.

FIG. 26 shows another embodiment of the socket connector 20 according to the present disclosure.

FIG. 27 shows another embodiment of the first mold part 20-5-1 according to the present disclosure.

### DETAILED DESCRIPTION OF EMBODIMENTS

The present disclosure may be variously modified and realized in many different forms, and thus specific embodiments will be exemplified in the drawings and described in detail hereinafter. However, the present disclosure should not be limited to the specific disclosed forms, and should be construed to include all modifications, equivalents, or replacements included in the spirit and scope of the present disclosure. Like components will be denoted by like reference numerals throughout the specification.

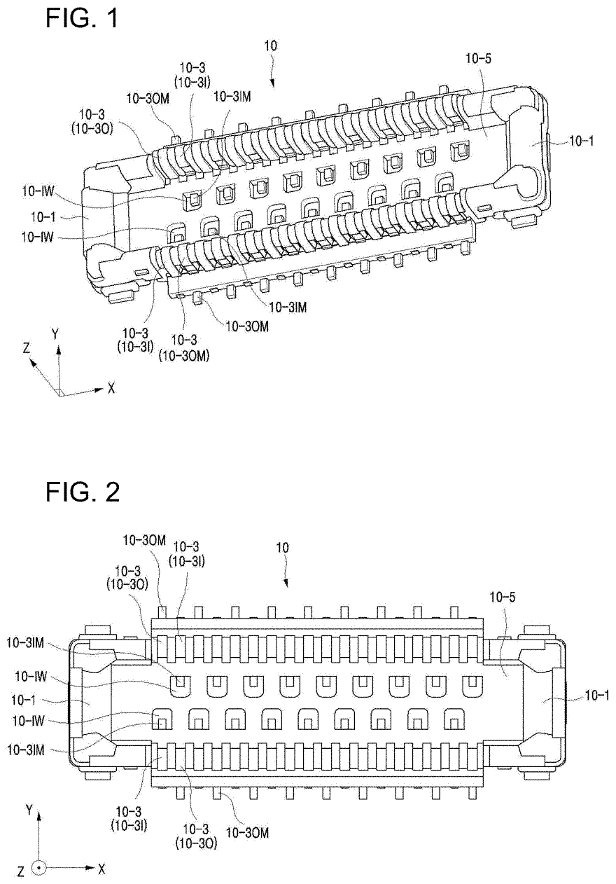

FIG. 1 is a perspective view of one embodiment of a plug connector in an electrical connector according to the present disclosure.

FIG. 1 shows one embodiment of a plug connector 10 that includes a fitting 10-1 (also acting as power terminals), a signal terminal 10-3, and a housing (mold) 10-5.

The fitting 10-1 may be a metal structure for reinforcing the connector 10. The fitting 10-1 acts as a power terminal through which electric power is input or output. Data signals may be input or output through the signal terminal 10-3.

It should be understood that this structure is provided by way of example and the present disclosure is not limited thereto. For example, the fitting 10-1 may also act as the power terminal and may be manufactured as a separate member.

Further, for example, the signal terminal 10-3 may be composed of a plurality of pins allowing a current of 0.3 A or may be a terminal allowing a current exceeding 0.3 A, for example, a current of 5 A, so as to act as a power terminal. By way of example, FIG. 1 shows the signal terminal including 36 pins.

The housing 10-5 has a base. The housing 10-5 has a wall protruding from an upper surface of the base and formed with the fitting 10-1, the signal terminal 10-3, and the like.

The housing (mold) 10-5 of the plug connector 10 is preferably formed of a plastic material, for example, a liquid crystal polymer (LCP). In addition, the housing 10-5 may be formed of an insulator including a resin and an epoxy resin, without being limited thereto. The fitting (power terminal) 10-1 and the signal terminal 10-3 of the plug connector 10 are preferably formed of a metallic material, for example, copper or a gold-plated copper alloy (nickel under-layer), without being limited thereto.

The fitting 10-1 may be formed of the same material as or a similar material to the signal terminal 10-3.

FIG. 2 is a front view of the plug connector 10 of FIG. 1.

Referring to FIG. 1 and FIG. 2, as the signal terminal 10-3, two types of terminals, that is, a signal terminal 10-3O in which mounting portions 10-3OM are disposed to face the exterior of the plug connector and a signal terminal 10-3I in which mounting portions 10-3IM are disposed to face the interior of the plug connector, are used together.

Referring to FIG. 2, the mounting portions 10-3OM of the signal terminal 10-3O are disposed outside the connector 10 (in the Y direction) and the mounting portions 10-3IM of the signal terminal 10-3I are disposed inside the connector 10 (in the Y direction).

The mounting portions 10-3IM of the signal terminal 10-3I may be observed through an inspection window 10-IW. Although it is possible to observe the mounting portions through the inspection window 10-IW with the naked eye, it is desirable that the inspection window 10-IW be used for machine vision through a device, such as camera or the like, for example, when the connector 10 according to the present disclosure is a very small connector used for a small electronic device, such as a smart phone and the like. It is possible to check, through the inspection window 10-IW, whether the inner mounting portions 10-3IM are properly mounted.

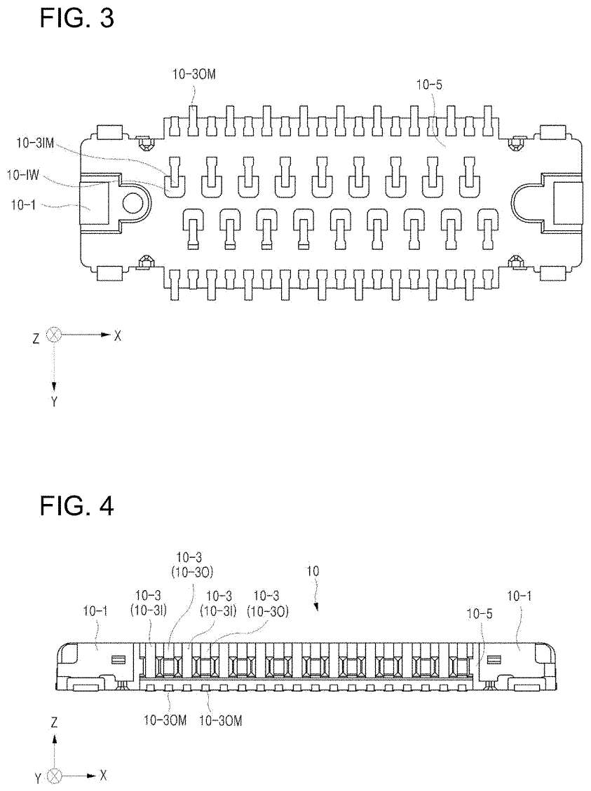

FIG. 3 is a bottom view of the plug connector 10 of FIG. 1.

As described with reference to FIG. 1 and FIG. 2, the mounting portions 10-3OM of the signal terminal 10-3O (hereinafter, also referred to as outer signal terminal) are disposed outside the connector 10 (in the Y direction) and the mounting portions 10-3IM of the signal terminal 10-3I (hereinafter, also referred to as inner signal terminal) are disposed inside the connector 10 (in the Y direction).

FIG. 4 is a side view of the plug connector 10 of FIG. 1.

Referring to FIG. 4, it can be seen that the outer mounting portions 10-30M are arranged one by one, as shown in FIG. 1.

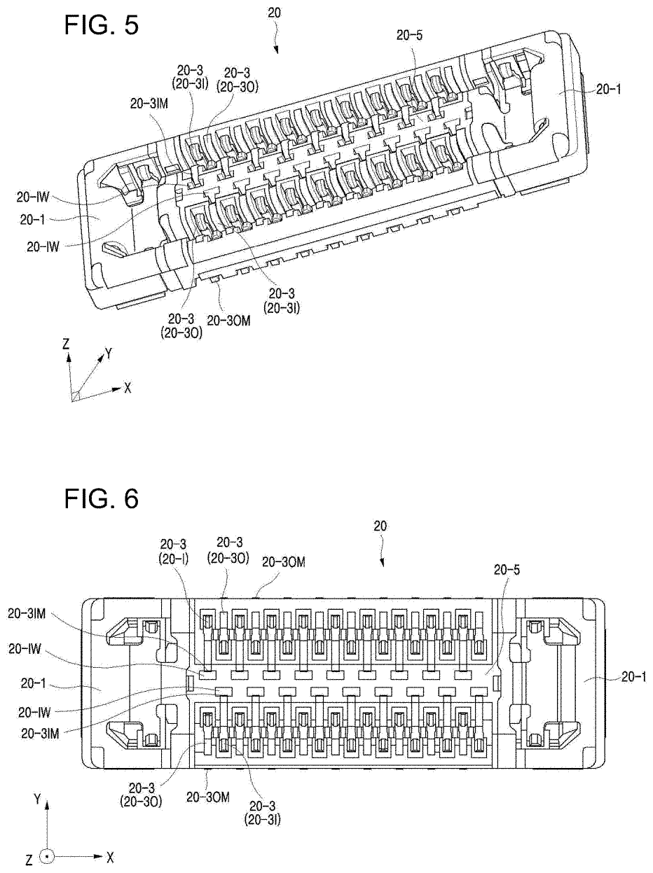

FIG. 5 is a perspective view of one embodiment of a socket connector of the electrical connector according to the present disclosure.

The socket connector 20 is also referred to as a receptacle connector 20.

Referring to FIG. 5, it can be seen that the plug connector 10 shown in FIGS. 1 to 4 is disposed upside down (in the Z direction) and connected to the socket connector 20 shown in FIGS. 5 to 8.

FIG. 5 shows one embodiment of the socket connector 20 that includes a fitting 20-1 (also acting as a power terminal), a signal terminal 20-3, and a housing (mold) 20-5.

The fitting 20-1 may be a metal structure for reinforcing the socket connector 20. The fitting 20-1 acts as a power terminal through which electric power is input or output. Data signals may be input or output through the signal terminal 20-3. The fitting 20-1 and the signal terminal 20-3 are fastened to the fitting 10-1 and the signal terminal 10-3 of the plug connector 10 of FIG. 1, respectively.

It should be understood that the structure shown in FIG. 5 is provided by way of example and the present disclosure is not limited thereto. For example, the fitting 20-1 may also act as a power terminal and may be manufactured as a separate member.

Further, by way of example, the signal terminal 20-3 may be composed of a plurality of pins allowing a current of 0.3 A or may be a terminal allowing a current exceeding 0.3 A, for example, a current of 5 A, so as to act as a power terminal. By way of example, FIG. 5 shows the signal terminal including 36 pins.

The housing 20-5 has a base. The housing 20-5 has a wall protruding from an upper surface of the base and formed with the fitting 20-1, the signal terminal 20-3, and the like. Further, the housing 20-5 has a central island protruding from an upper surface of the base. The central island of the housing 20-5 is partially covered by the fitting 20-1.

The housing (mold) 20-5 of the socket connector 20 is preferably formed of a plastic material, for example, a liquid crystal polymer (LCP). In addition, the housing 20-5 may be formed of an insulator including a resin and an epoxy resin, without being limited thereto. The fitting 20-1 and the signal terminal 20-3 of the socket connector 20 are preferably formed of a metallic material, for example, copper or a gold-plated copper allow (nickel under-layer), without being limited thereto.

The fitting 20-1 may be formed of the same material as or a similar material to the signal terminal 20-3.

FIG. 6 is a front view of the socket connector 20 of FIG. 5.

Referring to FIG. 5 and FIG. 6, as the signal terminal 20-3, two types of terminals, that is, a signal terminal 20-3O in which mounting portions 20-3OM are disposed to face the exterior of the socket connector and a signal terminal 20-3I in which mounting portions 20-3IM are disposed to face the interior of the socket connector, are used together.

Referring to FIG. 6, the mounting portions 20-3OM of the signal terminal 20-3O are disposed outside the connector 20 (in the Y direction) and the mounting portions 20-3IM of the signal terminal 20-3I are disposed inside the connector 20 (in the Y direction).

The mounting portions 20-3IM of the signal terminal 20-3I may be observed through an inspection window 20-IW. Although it is possible to observe the mounting portions through the inspection window 20-IW with the naked eye, it is desirable that the inspection window 20-IW be used for machine vision through a device, such as camera or the like, for example, when the connector 20 according to the present disclosure is a very small connector used for a small electronic device, such as a smart phone and the like. It is possible to check, through the inspection window 20-IW, whether the inner mounting portions 20-3IM are properly mounted.

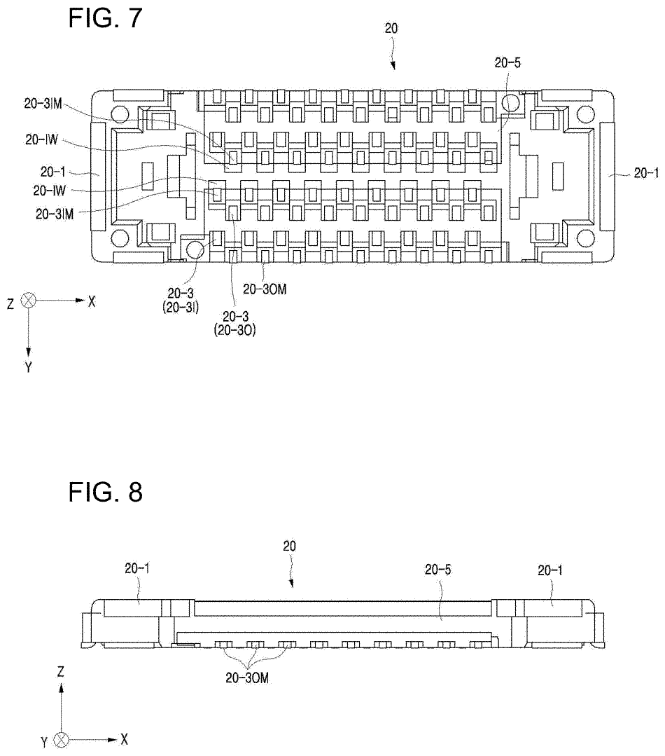

FIG. 7 is a bottom view of the socket connector 20 of FIG. 5.

As described with reference to FIGS. 5 and 6, the mounting portions 20-3OM of the signal terminal 20-3O (hereinafter, also referred to as outer signal terminal) are disposed outside the connector 20 (in the Y direction) and the mounting portions 20-3IM of the signal terminal 20-3I (hereinafter, also referred to as inner signal terminal) are disposed inside the connector 20 (in the Y direction).

FIG. 8 is a side view of the socket connector 20 of FIG. 5.

Referring to FIG. 8, it can be seen that the outer mounting portions 20-30M are arranged one by one, as shown in FIG. 5.

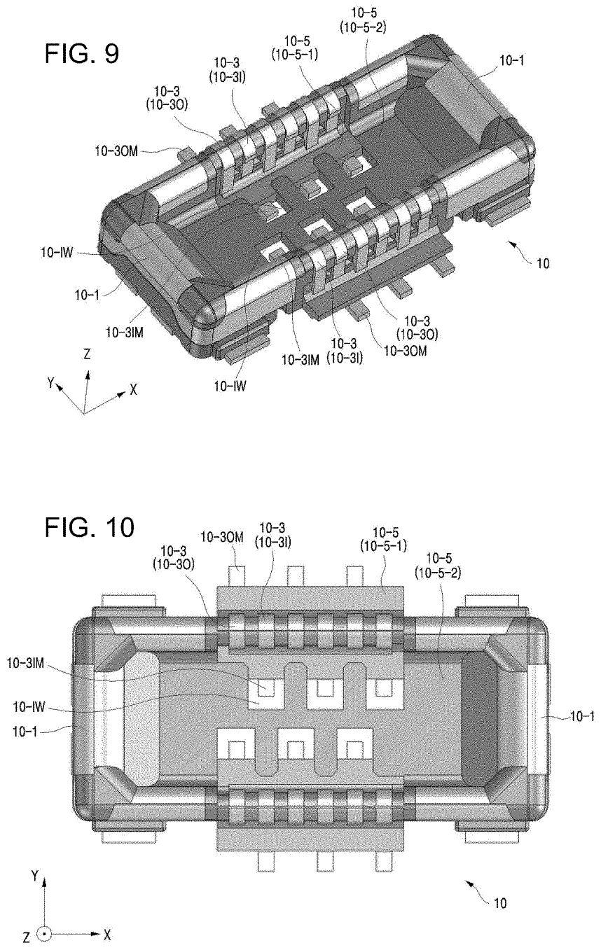

FIG. 9 is a perspective view of another embodiment of the plug connector of the electrical connector according to the present disclosure.

The plug connector 10 of FIG. 9 is similar to the plug connector 10 shown in FIGS. 1 to 4 excluding the number of pins of the signal terminal 10-3 and the mold 10-5 divided into a plurality of mold portions 10-5-1, 10-5-2, which are shown for clear understanding.

Since the number of pins of the signal terminal 10-3 can be changed, as needed, the plug connector 10 of FIG. 9 is not particularly different from the plug connector 10 shown in FIGS. 1 to 4.

In FIG. 9, the mold 10-5 is formed as two parts through insert molding performed twice instead of being formed as a single mass of resin. That is, a first mold part 10-5-1 is formed through insert-injection molding and a second mold part 10-5-2 is formed to surround a portion of the first mold part 10-5-1 through insert-injection molding. In this way, the mold 10-5 is formed through insert molding performed at least twice.

FIG. 10 is a front view of the plug connector 10 shown in FIG. 9.

Referring to FIG. 9 and FIG. 10, as the signal terminal 10-3, two types of terminals, that is, a signal terminal 10-3O in which mounting portions 10-3OM are disposed to face the exterior of the connector and a signal terminal 10-3I in which mounting portions 10-3IM are disposed to face the interior of the connector, are used together.

Referring to FIG. 10, the mounting portions 10-3OM of the signal terminal 10-3O are disposed outside the connector 10 (in the Y direction) and the mounting portions 10-3IM of the signal terminal 10-3I are disposed inside the connector 10 (in the Y direction).

The mounting portions 10-3IM of the signal terminal 10-3I may be observed through the inspection window 10-IW. Although it is possible to observe the mounting portions through the inspection window 10-IW with the naked eye, it is desirable that the inspection window 10-IW be used for machine vision through a device, such as camera or the like, for example, when the connector 10 according to the present disclosure is a very small connector used for a small electronic device, such as a smart phone and the like. It is possible to check, through the inspection window 10-IW, whether the inner mounting portions 10-3IM are properly mounted.

Further, it can be seen that, after formation of the first mold part 10-5-1, the second mold part 10-5-2 is formed to overlap the first mold part 10-5-1, thereby completing formation of the mold 10-5.

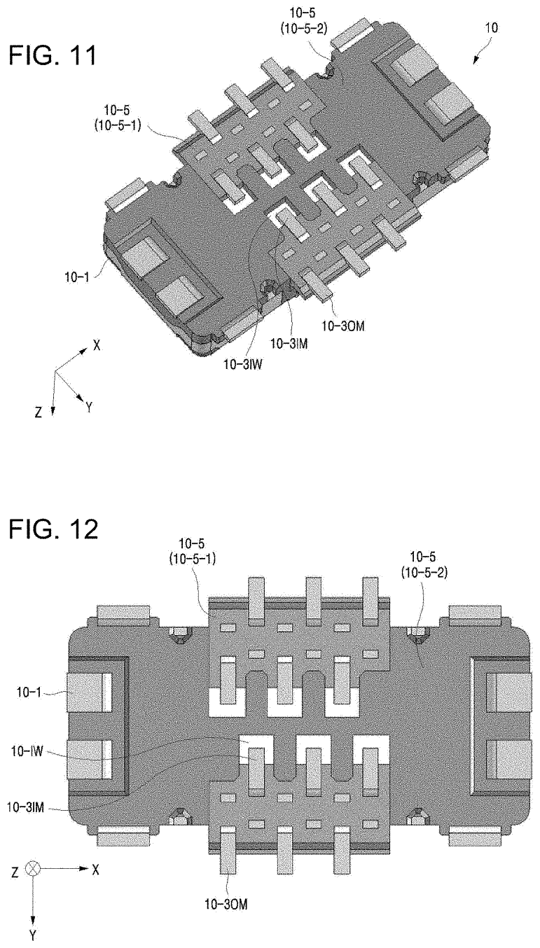

FIG. 11 is another perspective view of the plug connector 10 of FIG. 9 shown at a different angle.

As described with reference to FIGS. 9 and 10, the mounting portions 10-3OM of the signal terminal 10-3O (hereinafter, also referred to as outer signal terminal) are disposed outside the connector 10 (in the Y direction) and the mounting portions 10-3IM of the signal terminal 10-3I (hereinafter, also referred to as inner signal terminal) are disposed inside the connector 10 (in the Y direction).

Further, it can be seen that, after formation of the first mold part 10-5-1, the second mold part 10-5-2 is formed to overlap the first mold part 10-5-1, thereby completing formation of the mold 10-5.

FIG. 12 is a bottom view of the plug connector 10 shown in FIG. 9.

As described with reference to FIG. 11, the mounting portions 10-3OM of the outer signal terminal 10-3O are disposed outside the connector 10 (in the Y direction) and the mounting portions 10-3IM of the inner signal terminal 10-3I are disposed inside the connector 10 (in the Y direction).

Further, it can be seen that, after formation of the first mold part 10-5-1, the second mold part 10-5-2 is formed to overlap the first mold part 10-5-1, thereby completing formation of the mold 10-5.

Although it appears that this structure is different from the structure shown in FIG. 3, it does not mean that the mold 10-5 shown in FIGS. 1 to 4 is formed through a single molding operation. Rather, it should be understood that this structure includes a structure in which the mold 10-5 is formed through insert molding performed plural times, as shown in FIG. 12.

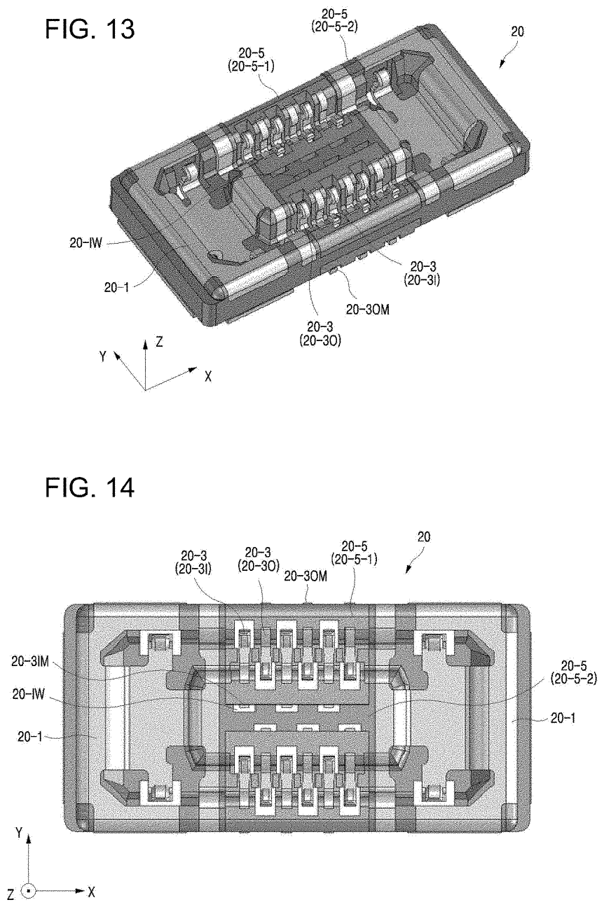

FIG. 13 is a perspective view of another embodiment of the socket connector in the electrical connector according to the present disclosure.

The socket connector 20 of FIG. 13 is coupled to the plug connector 10 shown in FIGS. 9 to 12.

In addition, the socket connector 20 of FIG. 13 is similar to the plug connector 10 shown in FIGS. 5 to 8 excluding the number of pins of the signal terminal 20-3 and the mold 20-5 divided into a plurality of mold portions 10-5-1, 10-5-2, which are shown for clear understanding.

Since the number of pins of the signal terminal 20-3 can be changed, as needed, the socket connector 20 of FIG. 13 is not particularly different from the plug connector 10 shown in FIGS. 5 to 8.

In FIG. 13, the mold 20-5 is formed as two parts through insert molding performed twice instead of being formed as a single mass of resin. That is, a first mold part 20-5-1 is formed through insert-injection molding and a second mold part 20-5-2 is formed to surround a portion of the first mold part 20-5-1 through insert-injection molding. In this way, the mold 20-5 is formed through insert molding performed at least twice.

Referring to FIG. 13, the central island is formed through combination of a portion of the first mold part 20-5-1 and a portion of the second mold part 20-5-2. In addition, the central island is formed with the inspection window 20-IW.

FIG. 14 is a front view of the socket connector 20 of FIG. 13.

Referring to FIG. 13 and FIG. 14, as the signal terminal 20-3, two types of terminals, that is, a signal terminal 20-3O in which mounting portions 20-3OM are disposed to face the exterior of the connector and a signal terminal 20-3I in which mounting portions 20-3IM are disposed to face the interior of the connector, are used together.

Referring to FIG. 14, the mounting portions 20-3OM of the signal terminal 20-3O are disposed outside the connector 20 (in the Y direction) and the mounting portions 20-3IM of the signal terminal 20-3I are disposed inside the connector 20 (in the Y direction).

The mounting portions 20-3IM of the signal terminal 20-3I may be observed through the inspection window 20-IW. Although it is possible to observe the mounting portions through the inspection window 20-IW with the naked eye, it is desirable that the inspection window 20-IW be used for machine vision through a device, such as camera or the like, for example, when the connector 20 according to the present disclosure is a very small connector used for a small electronic device, such as a smart phone and the like. It is possible to check, through the inspection window 20-IW, whether the inner mounting portions 20-3IM are properly mounted.

Further, it can be seen that, after formation of the first mold part 20-5-1, the second mold part 20-5-2 is formed to overlap the first mold part 20-5-1, thereby completing formation of the mold 20-5.

In addition, as shown in FIG. 14, a plurality of inspection windows 20-IW is arranged in a zigzag shape. This arrangement provides an effect of increasing the pitch of the signal terminal to two times a typical pitch. That is, assuming that a pitch of the signal terminals in the longitudinal direction of the connector 20 is A, since one signal terminal 10-3I is provided with the mounting portions 20-3IM disposed to face the interior of the connector 20 and another signal terminal 10-3O adjacent to the one signal terminal is provided with the mounting portions 20-3OM disposed to face the exterior of the connector 20, the pitch between the inner mounting portions 20-3IM becomes 2 A and the pitch between the outer mounting portions 20-3OM becomes at least 2 A.

In this way, a wider space than a typical pitch between adjacent terminals can be used as a pitch of the terminals upon mounting. Furthermore, due to the presence of the inspection windows 20-W, which are vertical through-holes in the height direction (Z direction), the mounted states of the inner mounting portions 20-3IM can be easily checked through a camera or the like.

It should be understood that the zigzag arrangement is provided by way of example and arrangement of the terminals may be modified as needed.

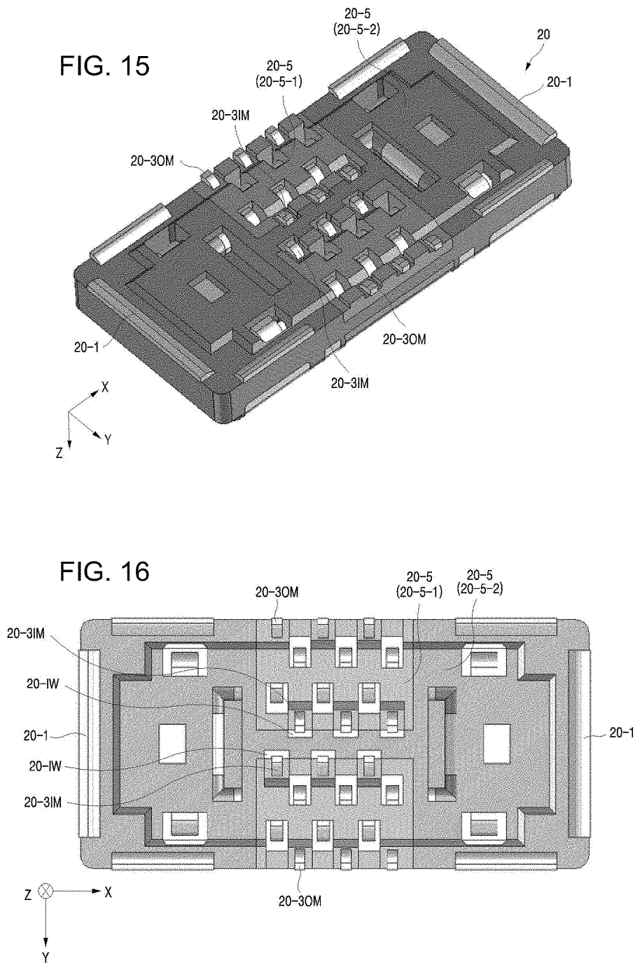

FIG. 15 is another perspective view of the socket connector 20 of FIG. 13 shown at a different angle.

As described with reference to FIGS. 13 and 14, the mounting portions 20-3OM of the signal terminal 20-3O (hereinafter, also referred to as outer signal terminal) are disposed outside the socket connector 20 (in the Y direction) and the mounting portions 20-3IM of the signal terminal 20-3I (hereinafter, also referred to as inner signal terminal) are disposed inside the socket connector 20 (in the Y direction).

Further, it can be seen that, after formation of the first mold part 20-5-1, the second mold part 20-5-2 is formed to overlap the first mold part 20-5-1, thereby completing formation of the mold 20-5.

FIG. 16 is a bottom view of the socket connector 20 shown in FIG. 13.

As described with reference to FIG. 15, the mounting portions 20-3OM of the outer signal terminal 20-3O are disposed outside the socket connector 20 (in the Y direction) and the mounting portions 20-3IM of the inner signal terminal 20-3I are disposed inside the socket connector 20 (in the Y direction).

Further, it can be seen that, after formation of the first mold part 20-5-1, the second mold part 20-5-2 is formed to overlap the first mold part 20-5-1, thereby completing formation of the mold 20-5.

Although it appears that this structure is different from the structure shown in FIG. 7, it does not mean that the mold 20-5 shown in FIGS. 5 to 8 is formed through a single molding operation. Rather, it should be understood that this structure includes a structure in which the mold 20-5 is formed through insert molding performed plural times, as shown in FIG. 16.

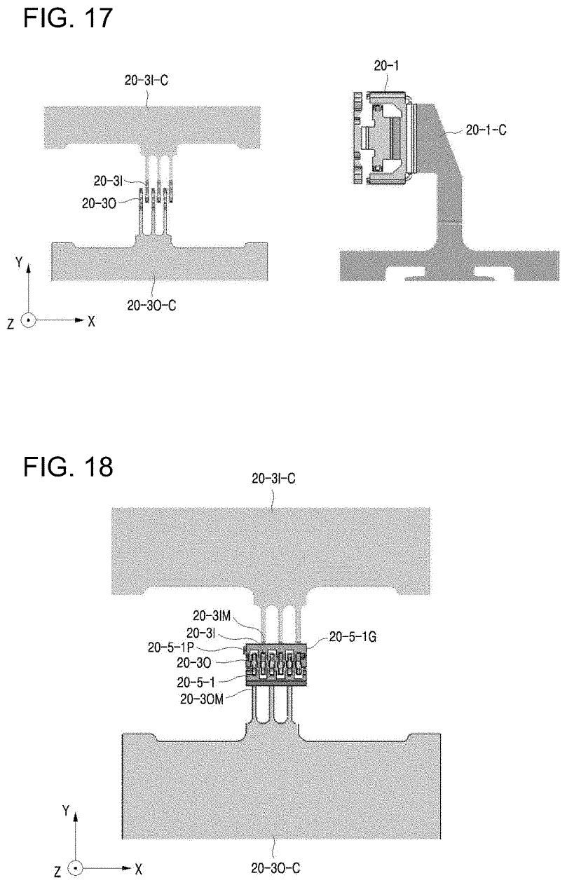

FIG. 17 shows the steps of preparing the signal terminal 20-3 and the fitting 20-1 in formation of the socket connector 20 shown in FIGS. 13 to 16.

In the first step for formation of the socket connector 20, as shown in FIG. 14, signal terminals 20-3 attached to a carrier are disposed. Referring to FIG. 14, six signal terminals 20-3 are arranged in one column in a −Y direction and six signal terminals 20-3 are arranged in one column in a +Y direction.

Referring to FIG. 17, among the six signal terminals 20-3 at the left side, the outer signal terminals 20-3O are attached to a signal terminal carrier 20-3O-C. In addition, among the six signal terminals 20-3, the inner signal terminals 20-3I are attached to a signal terminal carrier 20-3I-C. These signal terminals are, for example, six signal terminals 20-3 arranged in one column in the −Y direction, as shown in FIG. 14.

In addition, at the right side of FIG. 17, the fitting 20-1 is attached to a fitting carrier 20-1-C.

FIG. 18 shows the step of preparing the first mold part 20-5-1 in formation of the socket connector 20 shown in FIGS. 13 to 16.

As shown at the left side of FIG. 17, with six signal terminals disposed in place, the first mold part 20-5-1 is formed through primary insert molding. Referring to FIG. 18, the first mold part 20-5-1 is formed at a left side thereof with a protrusion 20-5-1P and at a right side thereof with a groove 20-5-1G. Although not clearly shown in FIG. 18, the groove 20-5-1G is formed in a shape corresponding to, for example, the protrusion 20-5-1P.

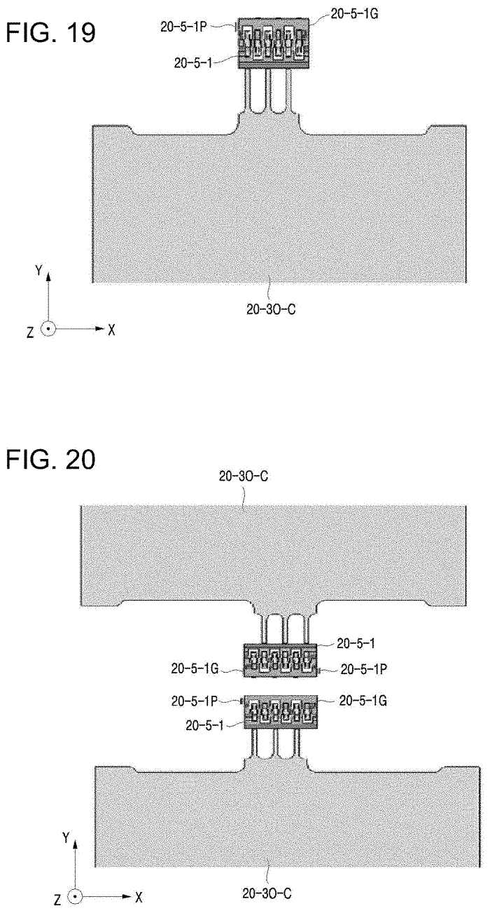

FIG. 19 shows the step of removing the carrier after preparation of the first mold part 20-5-1 in formation of the socket connector 20 shown in FIGS. 13 to 16.

FIG. 19 is the same as FIG. 18 except that the carrier 20-3I-C of the inner signal terminals 20-3I is removed. This structure provides a space in which one column of six signal terminals 20-3 shown in FIG. 19 will be arranged together with another column of six signal terminals 20-3.

FIG. 20 shows the step of placing two first mold parts 20-5-1 in formation of the socket connector 20 shown in FIGS. 13 to 16.

Two combinations of the first mold part 20-5-1 and the carrier 20-3O-C prepared as shown in FIG. 19 are disposed as shown in FIG. 20.

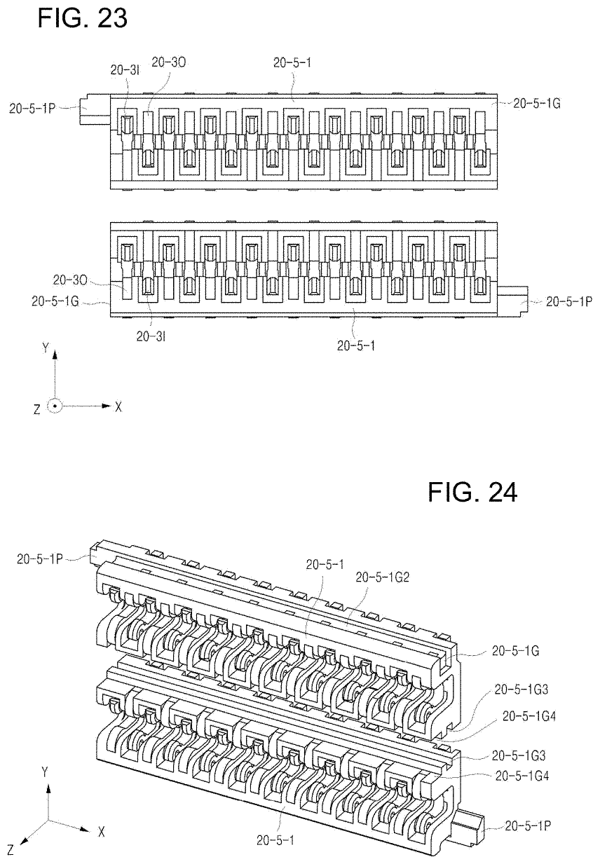

Details of the first mold part 20-5-1 shown in FIG. 20 will be described below with reference to FIGS. 23 and 24.

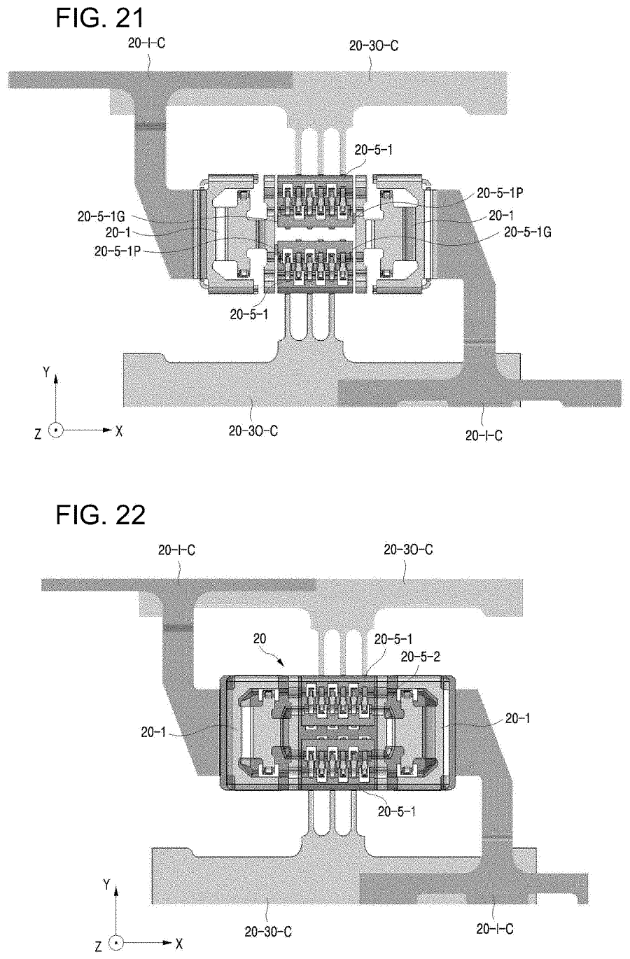

FIG. 21 shows the step of placing the fitting 20-1 after placement of the two first mold parts 20-5-1 in formation of the socket connector 20 shown in FIGS. 13 to 16.

The first mold part 20-5-1 is formed at one end thereof with the protrusion 20-5-1P and at the other end thereof with the groove 20-5-1G.

Referring to FIG. 21, it can be seen that at least two first fittings 20-1 are further disposed near the two first mold part 20-5-1 disposed as shown in FIG. 20. Here, the corresponding carriers 20-3O-C, 20-1-C are attached to the first mold part 20-5-1 and the first fitting 20-1, respectively.

FIG. 22 shows the step of insert molding the second mold part 20-5-2, with the first mold part 20-5-1 and the fitting 20-1 disposed in place, in formation of the socket connector 20 shown in FIGS. 13 to 16.

FIG. 22 shows the second mold part 20-5-2 together with the first mold part. In the course of forming the second mold part 20-5-2 through insert molding, an injection molded resin engages with the protrusion 20-5-1P and the groove 20-5-1G on the first mold part 20-5-1, whereby the second mold part 20-5-2 can be strongly coupled to the first mold part 20-5-1.

As shown in FIG. 22, the second mold part 20-5-2 surrounds, for example, three sides of the first mold part 20-5-1. It should be understood that, since the second mold part 20-5-2 makes slightly less contact with a portion of the first mold part corresponding to the inspection window 20-IW, as shown in FIG. 22, it is not necessary for the second mold part 20-5-2 to surround the entirety of three sides thereof. In this way, stronger coupling between the first mold part 20-5-1 and the second mold part 20-5-2 is achieved by forming the second mold part 20-5-2 to surround, for example, three sides of the first mold part 20-5-1.

The structure of the second mold part 20-5-2 surrounding the three sides of the first mold part is provided by way of example. More preferably, the first mold part 20-5-1 is further formed with grooves 20-5-1G2, 20-5-1G3, 20-5-1G4 in the longitudinal direction and the second mold part 20-5-2 surrounds four sides of the first mold part 20-5-1, as described below with reference to FIG. 24.

Although FIGS. 17 to 22 show the step of manufacturing the socket connector 20, this step may also be applied to manufacture of the plug connector 10.

FIG. 23 is a top view of one embodiment of the first mold part 20-5-1 shown in FIG. 20.

Referring to FIG. 23, two first mold parts 20-5-1 are disposed. The carrier 20-3O-C shown in FIG. 20 is omitted.

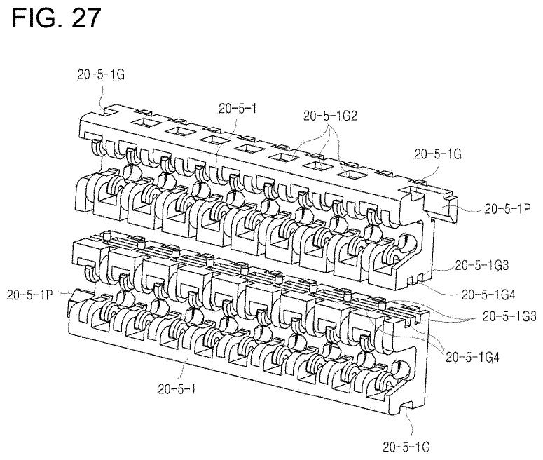

Although there is a slight difference in location of the protrusion 20-5-1P between FIG. 20 and FIG. 23, the protrusion 20-5-1P may be placed at any location of the first mold part 20-5-1 so long as the first mold part 20-5-1 is provided at one end thereof with the protrusion 20-5-1P and at the other end thereof with the groove 20-5-1G in the longitudinal direction (X direction). That is, the protrusion 20-5-1P may be placed at the right or left end of the first mold part 20-5-1 so long as the groove 20-5-1G is placed at an opposite side thereto. According to some embodiments, the first mold part 20-5-1 may be further provided with an additional groove 20-5-1G. For example, referring to FIG. 27, although the first mold part 20-5-1 is provided at one end thereof with the protrusion 20-5-1P and at the other end thereof with the groove 20-5-1G, it can be seen that this structure does not exclude the presence of another groove 20-5-1G at one end of the first mold part 20-5-1.

In addition, although there is a slight difference in location of the protrusion 20-5-1P in the Y direction between FIG. 20 and FIG. 23, the protrusion 20-5-1P may be disposed at any location of the first mold part 20-5-1 in the Y direction to be biased towards the +Y direction or the −Y direction or to be placed at the middle on the first mold part 20-5-1.

FIG. 24 is a perspective view of the first mold part 20-5-1 shown in FIG. 23.

Although FIG. 24 shows the first mold part 20-5-1 as shown in FIG. 23, it can be seen that additional grooves 20-5-1G2, 20-5-1G3, 20-5-1G4 may be present thereon.

Assuming that the groove 20-5-1G shown in FIG. 23 is referred to as a first groove, the grooves 20-5-1G2, 20-5-1G3, 20-5-1G4 may be referred to as a second groove 20-5-1G2, a third groove 20-5-1G3, and a fourth groove 20-5-1G4, respectively.

All of the second to fourth grooves 20-5-1G2, 20-5-1G3, 20-5-1G4 in addition to the first groove 20-5-1G1 extend in the longitudinal direction (Y direction) of the connector 20. The second to fourth grooves 20-5-1G2, 20-5-1G3, 20-5-1G4 are formed to be filled with a resin solution for the second mold part 20-5-2 upon secondary insert molding (that is, in the course of forming the second mold part 20-5-2 while proceeding from the state shown in FIG. 21 to the state shown in FIG. 22).

Although the first groove 20-5-1G is also filled with a resin solution, the second to fourth grooves 20-5-1G2, 20-5-1G3, 20-5-1G4 are also filled with the resin solution, whereby the second mold part 20-5-2 can be formed to surround substantially the entirety (that is, four sides) of the first mold part 20-5-1. This structure improves fastening strength between the first mold part 20-5-1 and the second mold part 20-5-2 and assists in improvement in overall strength of the connector 20.

For reference, the structure of the second mold part 20-5-2 surrounding the four sides of the first mold part 20-5-1 does not mean that all of the four sides thereof are completely surrounded by the second mold part 20-5-2. For example, the second mold part 20-5-2 may surround the first mold part 20-5-1 excluding portions thereof formed with the inspection windows 20-IW (see FIG. 16). In addition, although FIG. 24 shows the second groove 20-5-1G2 extending in the entirety of the longitudinal direction, it is not necessary for the second groove 20-5-1G2 to extend in the entirety of the longitudinal direction. In addition, the second groove 20-5-1G2 may be composed of two recesses extending in the longitudinal direction (for example, a structure in which no recess is formed between two recesses). This structure is also applied to the third recess 20-5-1G3 and the fourth groove 20-5-1G. Preferably, the recesses are formed to extend in the entire longitudinal direction in consideration of strength and the like.

Although FIG. 24 shows one elongated groove 20-5-1G2 formed on an outer wall of the first mold part 20-5-1 and two elongated grooves 20-5-1G3, 20-5-1G4 formed on an inner wall thereof, it should be understood that the present disclosure is not limited thereto. Since these grooves serve to allow an injection molded product (that is, a second injection molded product) to be efficiently secured to the first mold part upon secondary insert molding for manufacture of the second mold part 20-5-2, the number of grooves on the first mold part may be set, as needed, in consideration of strength or size. In this regard, it is believed that a certain level of securing force can be achieved by at least one groove on the inner wall of the first mold part and at least one groove on the outer wall thereof. The groove 20-5-1G2 filled with the second injection-molded product on the outer wall of the first mold part can be seen in FIGS. 13 and 15.

For reference, although FIGS. 17 to 24 illustrate one embodiment of the socket connector 20, it should be noted that the plug connector 10 may be manufactured based on the same principle as the socket connector 20.

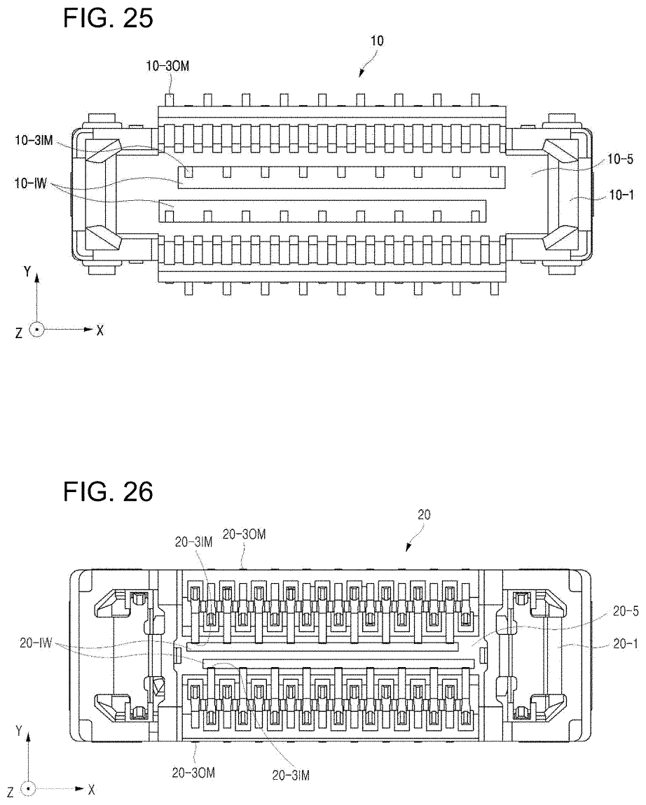

FIG. 25 shows another embodiment of the plug connector 10 according to the present disclosure.

The plug connector 10 shown in FIG. 25 is similar to the plug connector shown in FIG. 2 except that a plurality of mounting portions 10-3IM is exposed through one inspection window 10-IW instead of the structure wherein one inspection window 10-IW is provided with one mounting portion.

A structure wherein all inner mounting portions 10-3IM are provided to one inspection window 10-IW can be considered. However, since the connector 10 of this structure has low strength, this structure is not preferred. This structure can cause problems in use, for example, bending of a portion of the mold supporting a column of the signal terminals arranged in the longitudinal direction (X direction).

Accordingly, as shown in FIG. 25, it is desirable that one column of the signal terminals be allocated to one inspection window 10-IW and another column of the signal terminals be allocated to another inspection window 10-IW, without being limited thereto. Alternatively, two or three signal terminals 10-3 may be allocated to one the inspection window 10-IW.

In addition, the mold 10-5 shown in FIG. 25 may be formed through insert molding performed plural times (to form, for example, the first mold part 10-5-1 and the second mold part 10-5-2).

FIG. 26 shows another embodiment of the socket connector 20 according to the present disclosure.

The socket connector 20 of FIG. 26 corresponds to the plug connector 10 of FIG. 25.

The socket connector 20 shown in FIG. 26 is similar to the socket connector shown in FIG. 6 except that a plurality of mounting portions 20-3IM is exposed through one inspection window 20-IW instead of the structure wherein one inspection window 20-IW is provided with one mounting portion.

The mold 20-5 shown in FIG. 26 may be formed through insert molding performed plural times (to form, for example, a first mold part and a second mold part).

FIG. 27 shows another embodiment of the first mold part 20-5-1 according to the present disclosure.

The first mold part 20-5-1 shown in FIG. 27 is generally similar to the first mold part shown in FIG. 24 excluding some different features described hereinafter.

In the first mold part shown in FIG. 24, the second groove 20-5-1G2 extends as a single component in the longitudinal direction of the connector. In FIG. 24, the third groove 20-5-1G3 and the fourth groove 20-5-1G4 are formed in the same manner as in the second groove.

In modification of the first mold part shown in FIG. 27, the second groove 20-5-1G2 is divided into a plurality of second grooves in the longitudinal direction of the connector instead of extending as a single component in the longitudinal direction thereof. Although FIG. 27 shows seven second grooves 20-5-1G2, it should be understood that the present disclosure is not limited thereto so long as the second groove is provided in plural. In addition, referring to FIG. 27, each of the third groove 20-5-1G3 and the fourth groove 20-5-1G4 is divided into a plurality of grooves in the longitudinal direction of the connector.

Although the present disclosure discloses the structure wherein the first mold part 20-5-1 is provided at one end thereof with the protrusion 20-5-1P and at the other end thereof with the groove 20-5-1G, it should be understood that the first mold part 20-5-1 may be provided at one end thereof with a protrusion 20-5-1P (at an upper right side of FIG. 27) and at the other end thereof with another groove 20-5-1G (at the upper right side of FIG. 27) in addition to the groove 20-5-1G (at an upper left side of FIG. 27), as shown in FIG. 27.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it should also be understood that these embodiments are merely exemplary and are not intended to limit the scope of this disclosure.

### LIST OF REFERENCE NUMERALS

| | |
|---|---|
| 10: Plug connector | 10-1: Fitting |
| 10-3: Signal terminal | 10-3O: Outer signal terminal |
| 10-3O-M: Mounting portion of outer signal terminal | |
| 10-3I: Inner signal terminal | |
| 10-3I-M: Mounting portion of inner signal terminal | |
| 10-5: Housing (mold) | 10-5-1: First mold part |
| 10-5-2: Second mold part | 10-IW: Inspection window |
| 20: Receptacle connector (socket connector) | |
| 20-1: Fitting | 20-3: Signal terminal |
| 20-3O: Outer signal terminal | |
| 20-3O-M: Mounting portion of outer signal terminal | |
| 20-3I: Inner signal terminal | |
| 20-3I-M: Mounting portion of inner signal terminal | |
| 20-5: Housing (mold) | 20-5-1: First mold part |
| 20-5-1P: Protrusion | 20-5-1G: Groove (first groove) |
| 20-5-1G2: Second groove | 20-5-1G3: Third groove |
| 20-5-1G4: Fourth groove | 20-5-2: Second mold part |
| 20-IW: Inspection window | |

What is claimed is:

1. A method of manufacturing an electrical connector coupled to a counterpart connector, comprising:
(a) disposing a plurality of signal terminals;
(b) forming a first mold part to support the signal terminals through primary insert molding, the first mold part being formed to have a protrusion at one end thereof in a longitudinal direction of the electrical connector and a first groove at the other end thereof in the longitudinal direction of the electrical connector;
(c) placing a fitting beside the first mold part; and
(d) forming a second mold part to support the first mold part and the fitting through secondary insert molding, the second mold part being formed to surround the protrusion of the first mold part while filling the first groove.

2. The method according to claim 1, wherein, in Step (b), a second groove is further formed on the first mold part to extend in the longitudinal direction of the electrical connector.

3. The method according to claim 2, wherein the second groove comprises a plurality of grooves extending in the longitudinal direction of the electrical connector.

4. The method according to claim 2, wherein the first mold part comprises two first mold parts, and in Step (b), the second groove is formed on an outer wall of the first mold part and a third groove is further formed on an inner wall of the first mold part to extend in the longitudinal direction of the electrical connector.

5. The method according to claim 2, wherein, in Step (d), the second mold part is formed to surround four sides of the first mold part while surrounding the protrusion, the first groove, and the second groove.

6. The method according to claim 1, wherein a central island is formed on the electrical connector through combination of a portion of the first mold part and a portion of the second mold part.

7. An electrical connector coupled to a counterpart connector, comprising:
a plurality of signal terminals arranged in a longitudinal direction of the electrical connector,
a first mold part supporting the plurality of signal terminals, the first mold part having a protrusion at one end thereof in the longitudinal direction of the electrical connector and a first groove at the other end thereof in the longitudinal direction of the electrical connector;
a fitting disposed beside the first mold part; and
a second mold part supporting the first mold part and the fitting, the second mold part surrounding the protrusion of the first mold part and filling the first groove.

8. The electrical connector according to claim 7, wherein the first mold part is further formed with a second groove extending in the longitudinal direction of the electrical connector.

9. The electrical connector according to claim 8, wherein the electrical connector comprises two first mold parts; the second groove is formed on an outer wall of the first mold part; and a third groove is further formed on an inner wall of the first mold part to extend in the longitudinal direction of the electrical connector.

10. The electrical connector according to claim 8, wherein the second mold part is formed to surround four sides of the first mold part while surrounding the protrusion, the first groove, and the second groove.

11. The electrical connector according to claim 7, wherein a central island is formed on the electrical connector through combination of a portion of the first mold part and a portion of the second mold part.
